(19) United States
(12) Patent Application Publication
(10) Pub. No.: US 2012/0031239 A1
(43) Pub. Date: Feb. 9, 2012

(54) RETRACTABLE SCREWDRIVER

(75) Inventors: Che-I HU, Tainan Hsien (TW); Cheng-Tsan HU, Tainan Hsien (TW)

(73) Assignee: GONG FONG ENTERPRISE CO., LTD, Tainan Hsien (TW)

(21) Appl. No.: 12/852,754

(22) Filed: Aug. 9, 2010

(51) Int. Cl. B25B 15/04; B25B 23/16

(52) U.S. Cl. 81/62; 81/438; 81/177.2

(57) ABSTRACT

A retractable screwdriver includes a base, a first tube fitted on the base, a first transmission rod, a second tube, a second transmission rod, a rod member and a rotating member. The first transmission rod has a blind hole, a first engaging portion at one end and a gear shaft at the other end, and is axially meshing with a ratchet gear and inner teeth of a cap of the rotating member as well. The second transmission rod includes a through hole, a second engaging portion at one end to engage with the first engaging portion, and a threaded portion at an opposing end for a tightening nut to be secured thereon. The tightening nut enables to adjust the length of the rod member. The gear shaft meshes with the ratchet positioning assembly, preventing the screwdriver from reversing to an opposing direction.

### BACKGROUND OF THE INVENTION

1. Field of the Invention

This invention relates to a screwdriver, and more particularly to a retractable screwdriver with a precision ratchet positioning assembly.

2. Description of the Related Prior Art

Taiwan Patent Publication No. 586472 discloses “A structure of a precision screwdriver” related to a precision screwdriver, which comprises a sleeve at the top end of the connecting end of the screwdriver. The sleeve comprises a tube rod which has an axial through hole to receive a magnetic element therein to divide the tube rod into two sections, a front end and a rear end. A pair of ratable bits are inserted into the hole of the tube rod and secured by the magnetic element in the hole while the screwdriver is in use.

However, the screwdriver is limited to the two bits only if the object to be is worked on has a difference size. Thus, the screwdriver is useless. Further, the length of the bit is fixed. Should the object is located at a deeper location, the bit will have difficulty to reach.

Still further, many of the precision screwdrivers may not have a ratchet gear because the screwdriver is designed for a small object, such as small size screws. The ratchet gear may cause a counter torque when in operation, and may not tighten the screw.

### SUMMARY OF THE INVENTION

In view of the above shortcomings, a retractable screwdriver with a precision ratchet positioning assembly is invented and presented for a patent application. The retractable screwdriver comprises a base, a first tube, a first transmission rod, a second tube, a second transmission rod, a rod member, and a rotating member. The base comprises a receptacle and a through hole. The receptacle comprises a ratchet positioning assembly therein. The base further comprises a connecting portion. The first tube is fitted on the base. The first transmission rod is inserted into the through hole of the base. The first transmission rod has a blind hole therein. The first transmission rod has a first end and an opposing second end. The first end of the first transmission rod is provided with a gear shaft to mesh with a ratchet gear. The second end of the first transmission rod has a first engaging portion. The second tube has an opening to engage with the connecting portion of the base. The second transmission rod is inserted into the opening of the second tube. The second transmission rod has a through hole therein. The second transmission rod has a first end and an opposing second end. The first end of the second transmission rod has a second engaging portion to engage with the first engaging portion of the first transmission rod. The rod member is inserted into the through hole of the second transmission rod and the blind hole of the first transmission rod. The rotating member is fitted on the base. The rotating member has a through hole for the first transmission rod to insert therethrough.

Preferably, the second end of the second transmission rod has a threaded portion with a cut-off portion, and the threaded portion is connected with a tightening nut.

Preferably, the rod member has a first end and an opposing second end. The first end of the rod member has a circular groove to receive a washer. The second end of the rod member has a positioning trough therein.

Preferably, the ratchet positioning assembly comprises a circular positioning portion, at least six positioning recesses, two pawls and two elastic elements. The positioning portion is formed around an inner wall of the receptacle. The six positioning recesses are disposed on the positioning portion and divided into two sets. The elastic elements engage with the pawls, respectively. Each of the pawls comprises a pin pivoted in the receptacle. The rotating member further comprises two positioning pins and two push studs. Each of the positioning pins has a positioning protrusion to engage with a corresponding positioning recess.

Preferably, the base has a plurality of spaced troughs around an outer wall thereof and slots each disposed between every two adjacent troughs. The first tube comprises an outlet corresponding to the troughs and an elastic block corresponding to the slots.

Preferably, the rotating member comprises a knob and a cap disposed in the knob. The cap meshes with the gear shaft of the first transmission rod.

It is the primary object of the present invention to provide a retractable screwdriver, which comprises a base for bits to be stored therein, and a ratchet positioning assembly to secure the base with a first tube to minimize the size of the screwdriver, enabling to replace different bits.

It is another object of the present invention to provide a retractable screwdriver, which comprises a first engaging portion of a first transmission rod to engage with a second engaging portion of a second transmission rod. The two-section engagement of the two engaging portions enhances the strength of the transmission rods and eliminates the deformation of the material caused by the lengthy problem of the transmission rod.

It is still another object of the present invention to provide a retractable screwdriver, which comprises a ratchet positioning assembly disposed on top of the base for the user to monitor the movement with ease.

It is still another object of the present invention to provide a retractable screwdriver, which comprises a gear shaft at an upper end of the first transmission rod. The gear shaft extends into the cap and meshes with the gear. Thus, the cap is able to control rotation of the first transmission rod and also to eliminate the possible swing back torque force.

It is a further object of the present invention to provide a retractable screwdriver, which provides a number of troughs on the base to receive bits therein.

It is still a further object of the present invention to provide a retractable screwdriver, wherein the length of the rod member is adjustable in the first transmission rod and the second transmission rod.

### BRIEF DESCRIPTION OF THE DRAWINGS

FIG. 1 is an exploded view of the present invention;

FIG. 2 is a perspective view of the present invention;

FIG. 3 is a cross sectional view of FIG. 2;

FIG. 4 is a sectional view taken along line A-A of FIG. 3;

FIG. 5 is another sectional view taken along line B-B of FIG. 3;

FIG. 6 is a view similar to FIG. 4, showing a push stud forced by pawls and elastic elements to move so that positioning protrusions are switched to a new position and seating in another recesses;

FIG. 7 is a perspective view showing a bit taken out from the outlet of the first tube;

FIG. 8 is a perspective view showing the screwdriver operated by fingers; and

FIG. 9 is a cross sectional view showing adjustment of the rod member to extend within the through hole and the blind hole.

### DETAILED DESCRIPTION OF THE PREFRRED EMBODIMENT

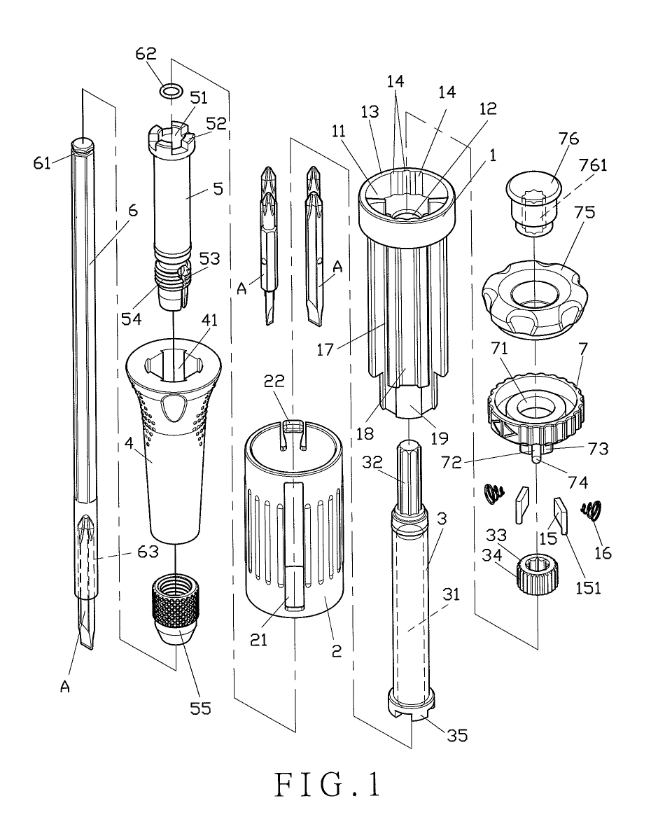

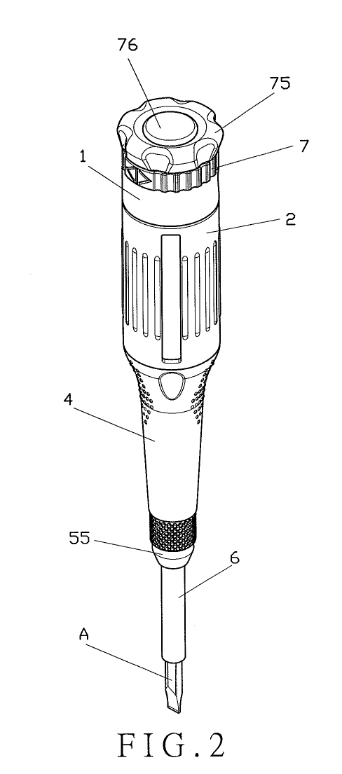

As shown in FIGS. 1, 2 and 3, a retractable screwdriver of the present invention comprises a base 1, a first tube 2, a first transmission rod 3, a second tube 4, a second transmission rod 5, a rod member 6 and a rotating member 7.

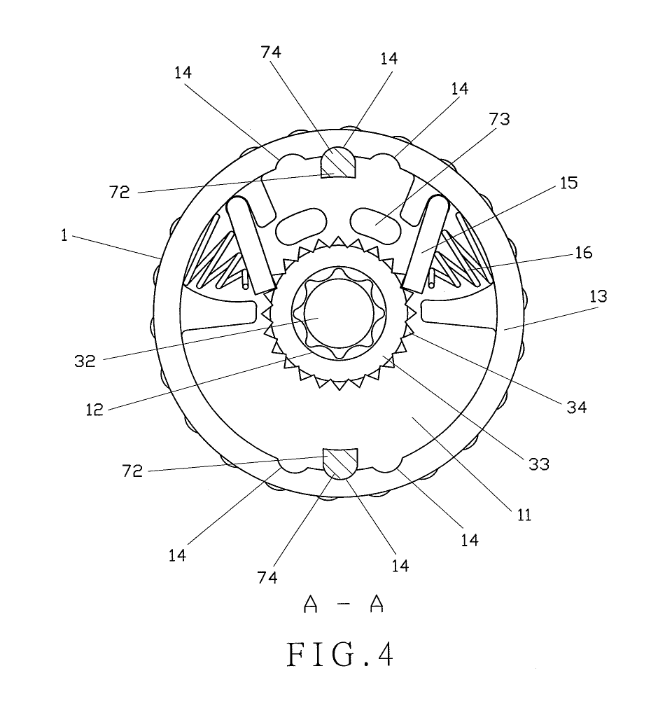

The base 1 comprises a receptacle 11 and a through hole 12 at an upper end thereof. The receptacle 11 comprises a ratchet positioning assembly therein, as shown in FIG. 4. The ratchet positioning assembly comprises a circular positioning portion 13, six positioning recesses 14, two pawls 15, and two elastic elements 16. The positioning portion 13 is formed around an inner wall of the receptacle 11. The six positioning recesses 14 are disposed on the positioning portion 13 and divided into two sets. The two elastic elements 16 hold against the two pawls 15, respectively. Each pawl 15 comprises a pin 151 to be pivoted in the receptacle 11. The base 1 has a number of troughs 17 equally spaced on an outer wall thereof. The troughs 17 are adapted to receive bits A therein. The base 1 has slots 18 each disposed between two adjacent troughs 17. The base 1 further comprises a connecting portion 19 extending downward from the base 1.

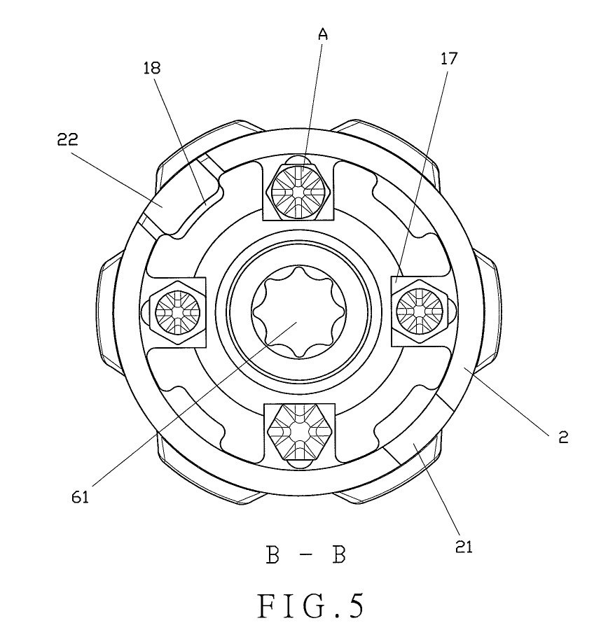

The first tube 2 fitted onto the base 1 comprises a longitudinal outlet 21 corresponding to the troughs 17 of the base 1 and an elastic block 22 corresponding to the slots 18. The elastic block 22 is engaged in one of the slots 18, as shown in FIG. 5.

The first transmission rod 3 is inserted into the through hole 12 of the base 1, and has a blind hole 31 therein. The first transmission rod 3 has a first end and a second end opposite to the first end. A gear shaft 32 is provided at the first end to mesh with teeth 34 of a ratchet gear 33. The teeth 34 are confined by the pawls 15 from moving freely. The second end of the first transmission rod 3 has a first engaging portion 35.

The second tube 4 has an opening 41 for the connecting portion 19 of the base 1 to be secured thereat.

The second transmission rod 5 is inserted into the opening 41 of the second tube 4. The second transmission rod 5 has a through hole 51 therein. The second transmission rod 5 has a first end and a second end opposite to the first end. The first end has a second engaging portion 52 to engage with the first engaging portion 35 of the first tube 3 in a rotating manner. The second end of the second transmission rod 5 has a cut-off portion 53 and a threaded portion 54. The threaded portion 54 is connected with a tightening nut 55.

The rod member 6 is inserted into the through hole 51 of the second transmission rod 5 and the blind hole 31 of the first transmission rod 3. The rod member 6 has a first end and a second end opposite to the first end. The first end of the rod member 6 has a circular groove 61 to receive a washer 62 therein. The second end of the rod member 6 has a positioning trough 63 for one of the bits A to be secured therein.

The rotating member 7 is fitted on top of the base 1 and has a through hole 71 for the first transmission rod 3 to insert therethrough. The rotating member 7 comprises two positioning pins 72 and two push studs 73. Each positioning pin 72 comprises a positioning protrusion 74 thereon. The positioning protrusion 74 is to engage with one of the positioning recesses 14 of the positioning portion 13 of the receptacle 11. Each push stud 73 is engaged with the pawl 15 so as to adjust the moving direction of the ratchet gear 33. The rotating member 7 further comprises a knob 75 with a cap 76 secured on top thereof. The cap 76 is formed with inner teeth 761 for meshing with the gear shaft 32 of the first transmission rod 3.

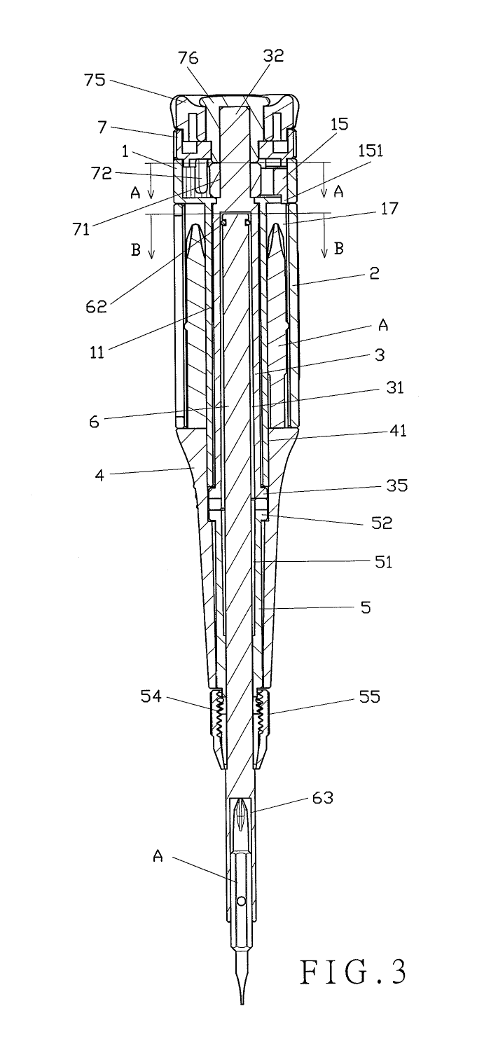

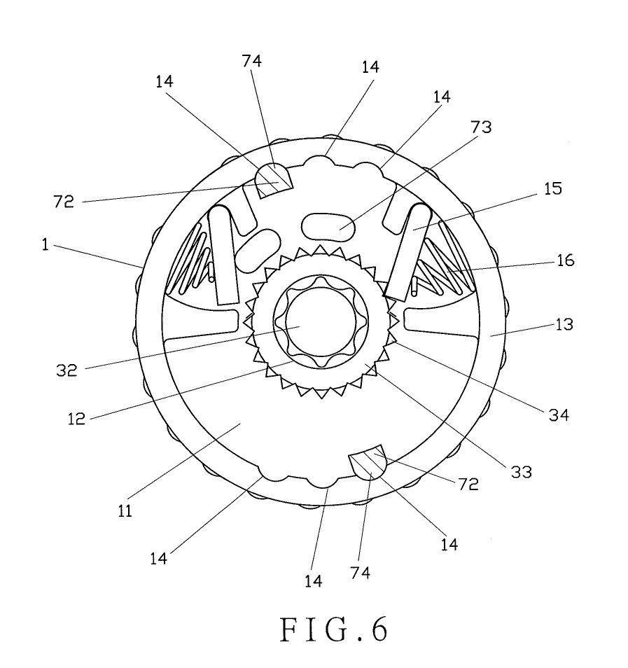

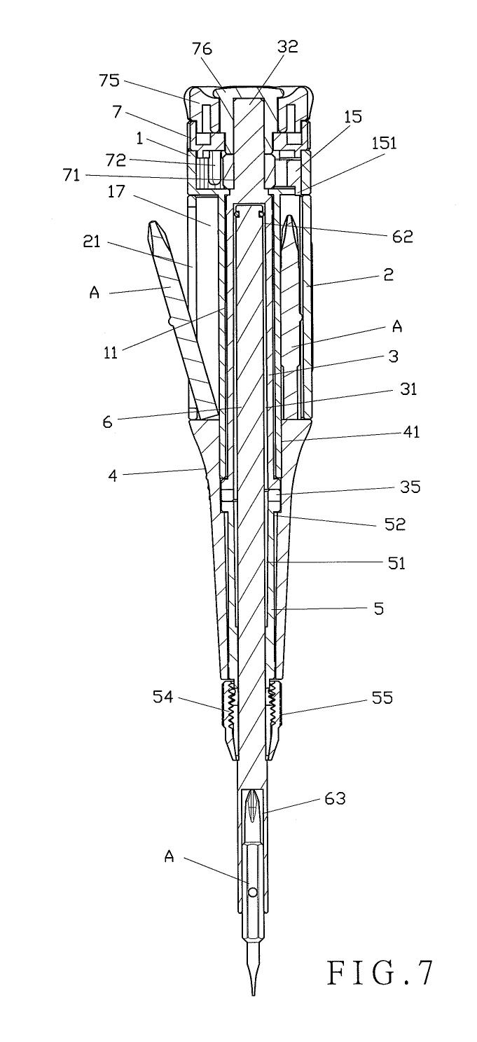

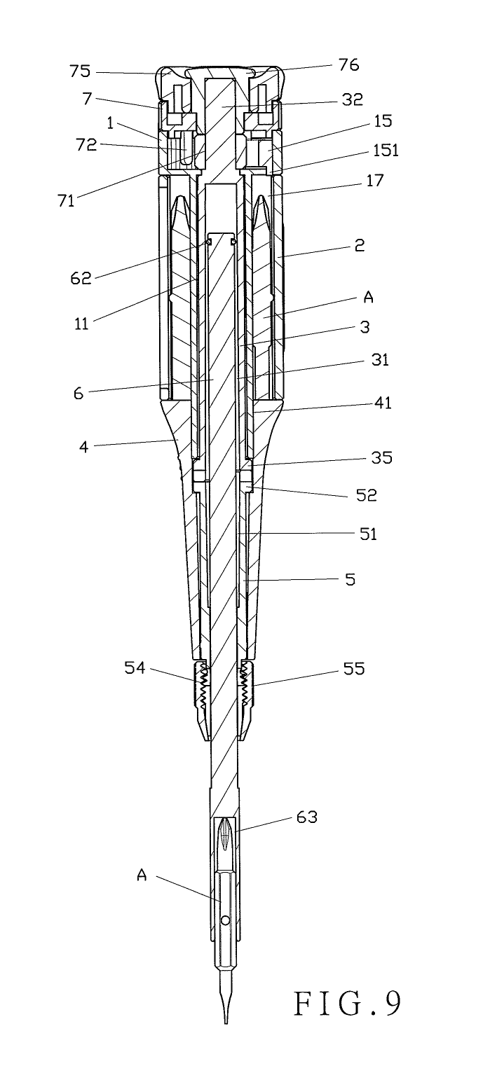

To operate the present invention, as shown in FIG. 1 and FIG. 6, the rotating member 7 is turned to force the positioning protrusions 74 of the positioning pins 72 to move into different recesses 14, which will adjust the turning direction as required. (This is a traditional technique to control the rotation of the ratchet and will not be described further.) Whereas, one of the push stubs 73 will force the pawl 15 to disengage from the teeth 34 of the ratchet gear 33, thus the ratchet gear 33 may rotate in a clockwise direction. Then, the first tube 2 is turned, which forces the elastic block 22 to disengage from the slot 18 of the base 1 and the first tube 2 is free to turn until the outlet 21 is aligned with one of the troughs 17 where a desired bit A is stored therein, thus the bit A is able to be taken out of the trough 17, as shown in FIG. 7. Upon the bit A is taken away, the first tube 2 is turned to move the outlet 21 away from its current recess 14 to seal the trough 17, and the elastic block 22 is seating into one of the slots 18 again. The bit A is then inserted into the positioning trough 63 of the rod member 6, as shown in FIG. 3. Whereby sliding the through hole 51 of the second transmission rod 5 and the blind hole 31 of the first transmission rod 3, the length of the rod member 6 may be adjusted, as shown in FIG. 9. When the desired length of the rod member 6 is done, the tightening nut 55 of the second transmission rod 5 is turned to fix the length of the rod member 6.

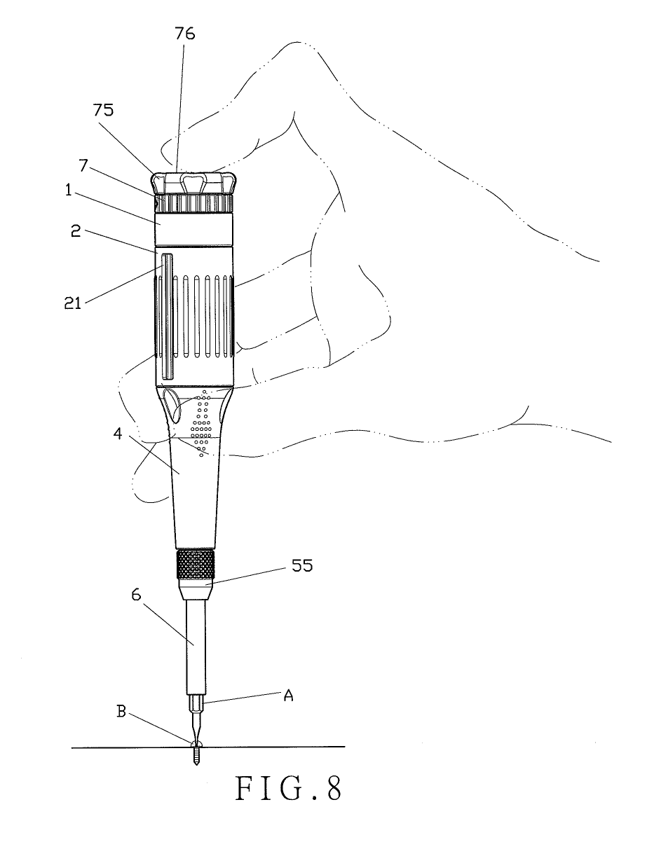

To hold the second tube 4 with the user's thumb and middle finger, as shown in FIG. 8, with the point finger pressing the cap 76 of the knob 75, the bit A will be engaged with the screw B. By turning the second tube 4, the first tube 2 links the first transmission rod 3, the second transmission rod 5 and the rod member 6 to turn the screw B in a clockwise direction. During the turning movement, both the first engaging portion 35 of the first transmission rod 3 and the second engaging portion 55 of the second transmission rod 5 transmit the turning force which reinforces the strength of the first transmission rod 3 and the second transmission rod 5. The higher position of the ratchet gear 33 provides a better view for the user to monitor the movement. The engagement of the gear shaft 32 of the first transmission rod 3 and the inner teeth 761 of the cap 76 prevents the ratchet gear from reversing.

The foregoing description of the specific embodiments will fully reveal the nature of this invention that others can, by applying current knowledge, readily modify, adapt for various applications, such specific embodiment without departing from the general concept, therefore such adaptations of the modifications should be and intended to be comprehended within the meaning and range of equivalents of the disclosed embodiments.

What is claimed is:

1. A retractable screwdriver, comprising:
a base comprising a receptacle and a through hole, said receptacle comprising a ratchet positioning assembly therein, said base further comprising a connecting portion;
a first tube fitted on said base;
a first transmission rod inserted into said through hole of said base, said first transmission rod having a blind hole therein, said first transmission rod having a first end and an opposing second end, the first end of said first transmission rod being provided with a gear shaft to mesh with a ratchet gear, the second end of said first transmission rod having a first engaging portion;
a second tube having an opening to engage with said connecting portion of said base;
a second transmission rod inserted into said opening of said second tube, said second transmission rod having a through hole therein, said second transmission rod having a first end and an opposing second end, the first end of said second transmission rod having a second engaging portion to engage with said first engaging portion of said first transmission rod;
a rod member inserted into said through hole of said second transmission rod and said blind hole of said first transmission rod; and
a rotating member fitted on said base, said rotating member having a through hole for said first transmission rod to insert therethrough.

2. The retractable screwdriver as claimed in claim 1, wherein said second end of said second transmission rod has a threaded portion with a cut-off portion, said threaded portion being connected with a tightening nut.

3. The retractable screwdriver as claimed in claim 1, wherein said rod member has a first end and an opposing second end, said first end of said rod member having a circular groove to receive a washer, said second end of said rod member having a positioning trough therein.

4. The retractable screwdriver as claimed in claim 1, wherein said ratchet positioning assembly comprises a circular positioning portion, at least six positioning recesses, two pawls and two elastic elements, said positioning portion being formed around an inner wall of said receptacle, said six positioning recesses being disposed on said positioning portion and divided into two sets, said elastic elements engaging with said pawls respectively, said pawls each comprising a pin pivoted in said receptacle, said rotating member further comprising two positioning pins and two push studs, said positioning pins each having a positioning protrusion to engage with a corresponding positioning recess.

5. The retractable screwdriver as claimed in claim 1, wherein said base has a plurality of spaced troughs around an outer wall thereof and slots each disposed between every two adjacent troughs, said first tube comprising an outlet corresponding to said troughs and an elastic block corresponding to said slots.

6. The retractable screwdriver as claimed in claim 1, wherein said rotating member comprises a knob and a cap disposed in the knob, said cap meshing with said gear shaft of said first transmission rod.
